(19) United States
(12) Patent Application Publication
(10) Pub. No.: US 2026/0205181 A1
(43) Pub. Date: Jul. 16, 2026

(54) METHODS FOR REPORTING THE NUMBER OF NON-ZERO COEFFICIENTS

(71) Applicant: Telefonaktiebolaget LM Ericsson (publ), Stockholm (SE)

(72) Inventors: Xinlin Zhang, Västra Frölunda (SE); Siva Muruganathan, Stittsville (CA); Shiwei Gao, Nepean (CA)

(21) Appl. No.: 19/138,206

(22) PCT Filed: Jan. 13, 2024
(86) PCT No.: PCT/IB2024/050353

§ 371 Date: Jun. 12, 2025

Related U.S. Application Data
(60) Provisional application No. 63/438,970, filed on Jan. 13, 2023.

(51) Int. Cl. H04B 7/06; H04B 7/0456

(52) U.S. Cl. CPC H04B 7/0626; H04B 7/0479; H04B 7/0634

(57) ABSTRACT

Systems and methods for reporting the number of non-zero coefficients are provided. In some embodiments, a method performed by a UE for reporting CSI includes: receiving a configuration for N_{TRP}>1 NZP CSI-RS resources; receiving CSI parameters including configuration of N_{L} parameter combinations, wherein each of the N_{L} parameter combinations is composed of a set {L₁, L₂, . . . , L_{N}_{_{TRP}}}, where Lₙ represents a number spatial domain basis vectors corresponding to the n^{th} NZP CSI-RS resource; determining a payload size of a number of CSI non-zero coefficients to be reported as part of the CSI using a first parameter combination among the N_{L} parameter combinations; performing measurements on the N_{TRP} NZP CSI-RS resources; and reporting CSI based on the performed measurements. In this way, the varying payload size problem for reporting K^{NZ} in Part 1 CSI can be solved. This makes it possible to decode Part 1 CSI without any ambiguity.

### RELATED APPLICATIONS

This application claims the benefit of provisional patent application Ser. No. 63/438,970, filed Jan. 13, 2023, the disclosure of which is hereby incorporated herein by reference in its entirety.

### TECHNICAL FIELD

The present disclosure relates generally to channel state information (CSI).

### BACKGROUND

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

A core component of the fifth Generation (5G) wireless network or New Radio (NR) is the support of MIMO antenna deployments and MIMO related techniques such as spatial multiplexing. Spatial multiplexing can be used to increase data rates in favorable channel conditions. FIG. 1 shows an example of spatial multiplexing. An information carrying symbol vector s is multiplied by an N_{T}×r precoding matrix or precoder W, which serves to distribute the transmit energy in a subspace of the N_{T} dimensional vector space. The precoding matrix is typically selected from a codebook of possible precoding matrices, and typically indicated by means of a precoding matrix indicator (PMI), which specifies a unique precoding matrix in the codebook for a given number of symbol streams. The r symbols in s each correspond to a MIMO layer and r is referred to as the transmission rank, which equals to the number of columns of the precoder W. In this way, spatial multiplexing is achieved since multiple symbols can be transmitted simultaneously over the same time/frequency resource element (RE). The number of symbols r is typically adapted to suit the current channel properties.

NR uses Orthogonal Division Multiplexing (OFDM) in downlink. The received N_{R}×1 vector yₙ at a User Equipment (UE) on a certain RE can be expressed as:

$${y}_{n} = {H}_{n} {Ws}_{n} + {e}_{n}$$

where eₙ is a receiver noise/interference vector. The precoder W can be constant over frequency (i.e., wideband), or frequency selective (i.e., per subband).

The precoder W is chosen to match the characteristics of the N_{R}×N_{T} MIMO channel matrix Hₙ, resulting in so-called channel dependent precoding. This is also commonly referred to as closed-loop precoding.

In closed-loop precoding, the UE feeds back recommendations on a suitable precoder to the New Radio Base Station (gNB) in the form of a PMI based on downlink channel measurements. For that purpose, the UE is configured with a channel state information (CSI) report configuration including CSI reference signals (CSI-RS) for channel measurements and a codebook of candidate precoders. In addition to precoders, the feedback may also include a rank indicator (RI) and one or two channel quality indicators (CQIs). RI, PMI and CQI are part of a CSI feedback. In NR, CSI feedback can be either wideband, where one CSI is reported for the entire channel bandwidth, or frequency-selective, where one CSI is reported for each subband, which is defined as a number of contiguous physical resource blocks (PRBs) ranging between 4-32 PRBs depending on the band width part (BWP) size.

Given the CSI feedback from the UE, the gNB determines the transmission parameters it wishes to use to transmit to the UE, including the precoding matrix, transmission rank, and modulation and coding scheme (MCS).

### 2D Antenna Arrays

Two-dimensional antenna arrays are widely used, and such antenna arrays can be described by a number of antenna ports, N₁, in a first dimension (e.g., the horizontal dimension), a number of antenna ports, N₂, in the second dimension perpendicular to the first dimension (e.g., the vertical dimension), and a number of polarizations Nₚ. The total number of antenna ports is thus N=N₁N₂Nₚ. The concept of an antenna port is non-limiting in the sense that it can refer to any virtualization (e.g., linear mapping) to the physical antenna elements. For example, pairs of physical antenna elements could be fed the same signal, and hence share the same virtualized antenna port.

An example of a 4×4 (i.e., N₁×N₂) array with dual-polarized antenna elements (i.e., Nₚ=2) is illustrated in FIG. 2. FIG. 2 illustrates of a two-dimensional antenna array of dual-polarized antenna elements (Nₚ=2), with N₁=4 horizontal antenna elements and N₂=4 vertical antenna elements.

Precoding may be interpreted as multiplying the signal to be transmitted by a set of beamforming weights on the antenna ports prior to transmission. A typical approach is to tailor the precoder to the antenna form factor, i.e., taking into account N₁, N₂ and Nₚ when designing the precoder codebook.

### Channel State Information Reference Signals (CSI-RS)

For CSI measurement and feedback, CSI-RS are defined. A CSI-RS is transmitted on an antenna port at the gNB and is used by a UE to measure downlink channel between the antenna port and each of the UE's receive antenna ports. The transmit antenna ports are also referred to as CSI-RS ports. The supported number of CSI-RS ports in NR are {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 3 shows an example of CSI-RS REs for 12 antenna ports, where 1 RE per resource block (RB) per port is shown.

In addition, interference measurement resource (IMR) is also defined in NR for a UE to measure interference. An IMR resource contains 4 REs, either 4 adjacent RE in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI. Furthermore, a UE in NR may be configured to measure interference based on one or multiple NZP CSI-RS resource.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource setting for channel measurement
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, CQI, and CSI-RS resource indicator (CRI) in case of multiple CSI-RS resources in a resource set
Codebook types, i.e., type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

### NR Rel-15 Type II Codebook

In NR Rel-15, precoders are enhanced based on a type II codebook, in which a precoder is a combination of multiple Discrete Fourier Transform (DFT) beams. For each precoder, the UE feeds back the corresponding selected multiple DFT beams and the combination coefficients. A precoder may be reported for each layer and each subband. A common set of DFT beams are selected for all subbands and all layers. The number of DFT beams to be selected is Radio Resource Control (RRC) configured.

For a given 2D cross-polarized antenna array with N₁ antenna ports in one dimension and N₂ antenna ports in another dimension at each polarization, the NR Rel-15 type II codebook-based precoding vector for each layer l∈{1,2} can be expressed as

$${w}_{l} = {W}_{1} {w}_{2 , l}$$

For details, refer to section 5.2.2.2.3 of TS38.214 V17.3.0.

NR Rel-16 Enhanced Type II (eType II) Codebook

The Rel-15 type II codebook is enhanced in NR Rel-16 in which instead of reporting separate precoders for different subbands, the precoders for all subbands are reported together by using a so-called frequency domain (FD) basis. It takes advantage of frequency domain channel correlations by representing the precoder changes in frequency domain with a set of frequency domain DFT basis vectors (which will be simply referred to as frequency domain basis vectors). Due to channel correlation in frequency, only a few DFT basis vectors may be used to represent the precoder changes over all the subbands. By doing so, the feedback overhead can be reduced or performance can be improved for the same feedback overhead. For a given CSI-RS resource with N₁ CSI-RS antenna ports in one dimension and N₂ CSI-RS antenna ports in another dimension. For details, refer to section 5.2.2.2.5 of TS38.214 V17.3.0.

### NR Rel-16 Enhanced Type II Port Selection Codebook

The enhanced Type II (eType II) port selection (PS) codebook was also introduced in Rel-16, which is intended to be used for beamformed CSI-RS, i.e., each CSI-RS port corresponds a 2D spatial beam. Based on the measurement, the UE selects the best CSI-RS ports and recommends a rank, a precoding matrix, and a CQI conditioned on the rank and the precoding matrix to the gNB. The precoding matrix comprises linear combinations of the selected CSI-RS ports. For details, refer to section 5.2.2.2.6 of TS38.214 V17.3.0.

For Rel-16 Enhanced Type II CSI feedback, a CSI report comprises of two parts. Part 1 has a fixed payload size and is used to identify the number of information bits in Part 2. Part 1 contains RI, CQI, and an indication of the overall number of non-zero amplitude coefficients across layers, i.e.,

$${K}_{tot}^{NZ} ∈ \{ 1 , 2 , … , 2 {K}_{0} \} .$$

Part 2 contains the PMI. Part 1 and 2 are separately encoded.

### NR Rel-17 Further Enhanced Type II Port Selection Codebook

The Rel-16 port selection codebook is further enhanced in Rel-17, in which it is assumed that each CSI-RS port is associated to a channel delay and different channel delays are associated to different CSI-RS ports. It is also assumed that the delays associated to the CSI-RS ports have been pre-compensated before being transmitted and thus, only one or two frequency domain basis vectors may be selected by a UE, i.e., Mᵥ∈{1, 2}. The one or two FD basis vectors are the same for all layers, therefore M is used instead of Mᵥ.

The number, L, of CSI-RS ports or beams at each polarization to be selected is indirectly configured as L=αP_{CSI-RS}/2, where parameter a is configured by RRC as shown in Table 3. The 2 L total CSI-RS ports are selected from P_{CSI-RS} ports based on L port selection vectors, eₘ_{⁽ⁱ⁾}, i=0, 1, . . . , L−1. For details, refer to section 5.2.2.2.7 of TS38.214 V17.3.0.

Coherent Joint Physical Downlink Shared Channel (PDSCH) Transmission from Multiple Transmission and Reception Points (TRPs)

In NR Rel-18, it has been agreed to support coherent joint downlink transmission (CJT) from multiple transmission and reception points TRPs by extending Rel-16 and Rel-17 enhanced type II codebook across multiple TRPs. In case of CJT, each layer of a PDSCH is transmitted from multiple TRPs. An example is shown in FIG. 4, where a PDSCH with two layers is transmitted from two TRPs by applying two different precoding matrices to the PDSCH at TRP1 and TRP2. The two precoders are designed such that for each layer, the signals received from the two TRPs are phase aligned at the UE and thus, are coherently combined at the UE.

Extension of NR Rel-16 type II codebook to CJT has been discussed in 3GPP and two modes of codebook structures for supporting CJT have been agreed as follows:
Mode 1: Per-TRP/TRP-group spatial domain/frequency domain (SD/FD) basis selection which allows independent FD basis selection across N TRPs/TRP groups. Example formulation (N=number of TRPs or TRP groups):

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2: Per-TRP/TRP group (port-group or resource) SD basis selection and joint/common (across N TRPs) FD basis selection. Example formulation (N=number of TRPs or TRP groups):

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

Where W_{1,n} contains the selected beams or SD basis vectors for the nth TRP, W_{f,n} is the selected FD basis vectors associated to the nth TRP, \tilde{W}_{2,n} contains the coefficients associated with the nth TRP, W_{f} is a common set of selected FD basis vectors across all TRPs.

Relevant agreements from 3GPP RAN1 #111 [Error! Reference source not found.]

### Agreement

On the Type-II codebook refinement for CJT mTRP, regarding the SD basis selection, for a configured value of N_{TRP}, a set of N_{L} combinations of values for {L₁, L₂, . . . , L_{N}_{_{TRP}}} is gNB-configured via higher-layer (RRC) signalling
When N_{L}>1, the selected combination of values for {L₁, L₂, . . . , L_{N}_{_{TRP}}} is reported in CSI part 1 using an indicator, selected from the N_{L} configured combinations
   N_{L} is one of the supported candidate values
   FFS: Other supported value(s) of N_{L}, and its respective UE capability
   FFS: The supported combinations of values for {L₁, L₂, . . . , L_{N}_{_{TRP}}}
Following the legacy design, the SD basis selection for the n-th (n=1, . . . , N) selected CSI-RS resource is indicated in CSI part 2 using a combinatorial indicator selected from a set of

$$( \begin{matrix}{P}_{CSI - RS} / 2 \\ {L}_{n}\end{matrix} )$$

odepoints where, for Rel-16-based refinement P_{CSI-RS}=2N₁N₂.
The supported candidate values for each of the Lₙ parameters include the legacy candidate values, i.e., {2,4,6} for Rel-16-based refinement, and
   for Rel-17-based refinement, the gNB configures a set of N_{L} combinations for

$$\{ {α}_{1} , … , {α}_{{N}_{TRP}} \} , {L}_{n} = {α}_{n} {P}_{CSI - RS} / 2 , where {α}_{n} = \{ \frac{1}{2} , \frac{3}{4} , 1 \} .$$

FFS: Whether the set of N_{L} combinations of values for {L₁, L₂, . . . , L_{N}_{_{TRP}}} can be implicitly derived.

Following the legacy design, for all the selected N CSI-RS resources, the SD basis oversampling group for each CSI-RS resource is indicated in CSI part 2 using an indicator selected from a set of O₁O₂ codepoints.

There currently exist certain challenge(s). In legacy Type II codebooks that are introduced after 3GPP Rel-15, e.g., the Rel-16 enhanced Type II (eType II) codebook and the Rel-17 further enhanced Type II port selection (feType II PS) codebook, the total number of non-zero coefficients (NNZCs) across all layers, denoted by K^{NZ}, is reported by the UE in Part 1 of CSI. For rank 1 PMI, K^{NZ}≤K₀, while for rank>1 PMI, K^{NZ}≤2K₀, where K₀=┌β2LM₁┐ with β, L, M₁ being higher layer configured, which have fixed values for a given parameter configuration. Hence, for indicating/reporting K^{NZ}, the required payload size (┌log₂(K₀)┐ bits for rank 1 and ┌log₂(2K₀)┐ bits for rank>1) depends on K₀ which has a fixed value.

For Type II codebook enhancement for CJT, the number of selected SD basis vectors, the number of FD basis vectors, and the ratio β which controls the maximum number of reported NNZCs, may be configured in a way so that one or multiple of these codebook parameters may have more than one possible values, and it is up to the UE to determine which value to use for each codebook parameter. One possibility is that the configuration of these codebook parameters is done via multiple hypotheses, where different hypotheses may have different values for these codebook parameters.

Consequently, the value K₀ is not known before the UE has determined the value for each of the codebook parameters that has more than one possible values, making the payload size for reporting K^{NZ} in CSI Part 1 a variable. If the legacy reporting mechanism is reused, a variable/unknown payload size in CSI Part 1 makes decoding the CSI report impossible which is a problem. Improved systems and methods for reporting the number of non-zero coefficients is needed.

### SUMMARY

Systems and methods for reporting the number of non-zero coefficients are provided. In some embodiments, a method performed by a UE for reporting CSI includes: receiving a configuration for a first number N_{TRP}>1 NZP CSI-RS resources; receiving one or more CSI parameters including configuration of a second number N_{L} of parameter combinations, wherein each of the N_{L} parameter combinations is composed of a set {L₁, L₂, . . . , L_{N}_{_{TRP}}}, where Lₙ represents a number of SD basis vectors corresponding to the n^{th} NZP CSI-RS resource; determining a payload size of a number of CSI non-zero coefficients to be reported as part of the CSI using a first parameter combination among the N_{L} parameter combinations; performing measurements on the N_{TRP} NZP CSI-RS resources; and reporting CSI based on the performed measurements. In this way, the varying payload size problem for reporting K^{NZ} in Part 1 CSI can be solved. This makes it possible to decode Part 1 CSI without any ambiguity.

In some embodiments, a method performed by a network node for receiving CSI includes: configuring a UE with a configuration for a first number N_{TRP}>1 NZP CSI-RS resources; configuring the UE with one or more CSI parameters including configuration of a second number N_{L} parameter combinations, wherein each of the N_{L} parameter combinations is composed of a set {L₁, L₂, . . . , L_{N}_{_{TRP}}}, where Lₙ represents a number of SD basis vectors corresponding to the n^{th} NZP CSI-RS resource; determining a payload size of a total number K^{nz} of non-zero coefficients to be reported as part of the CSI using a first parameter combination among the N_{L} parameter combinations; and receiving, from the User Equipment, UE, CSI based on measurements performed on N_{TRP} CSI-RS resources.

In some embodiments disclosed herein, systems and methods for resolving the varying payload size problem for reporting K^{NZ} in Part 1 CSI are provided (e.g., by allocating a fixed and sufficient payload size). In the proposed embodiments, rules are defined on how to allocate a sufficient payload size for reporting K^{NZ}.

In some embodiments, the UE receives Type II CSI parameters including configuration of N_{L} parameter combinations whereas each of the N_{L} parameter combinations is composed of a set {L₁, L₂, . . . L_{N}_{_{TRP}}} wherein Lₙ represents the SD basis vectors corresponding to the n^{th} CSI-RS resource.

In some embodiments, the UE determines a first parameter combination among the parameter combinations that results in the maximum number of SD basis vectors

$${\sum }_{n = 1}^{{N}_{TRP}} {L}_{2} ,$$

and determining the payload size of the number of Type II CSI non-zero coefficients to be reported as part of the CSI using the first parameter combination.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of spatial multiplexing;

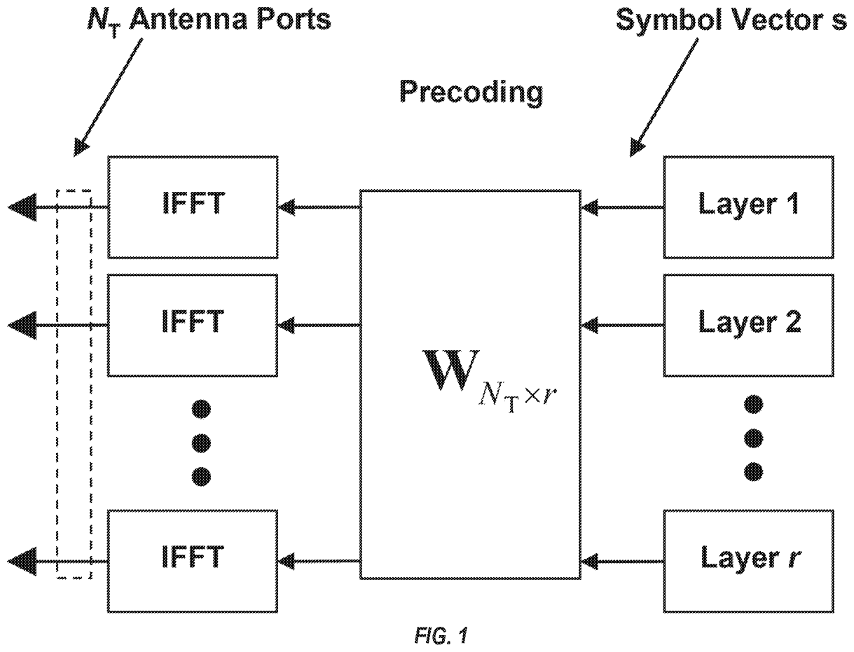

FIG. 2 illustrates of a two-dimensional antenna array of dual-polarized antenna elements (Nₚ=2), with N₁=4 horizontal antenna elements and N₂=4 vertical antenna elements;

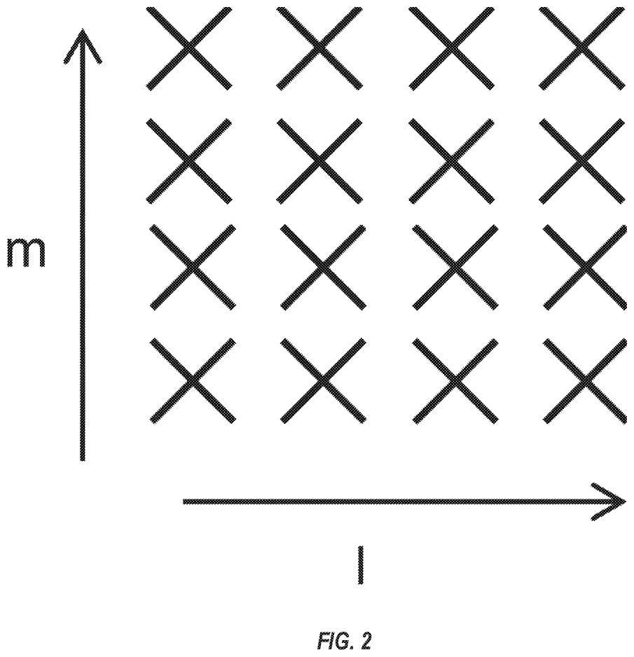

FIG. 3 shows an example of CSI-RS REs for 12 antenna ports, where 1 RE per RB per port is shown;

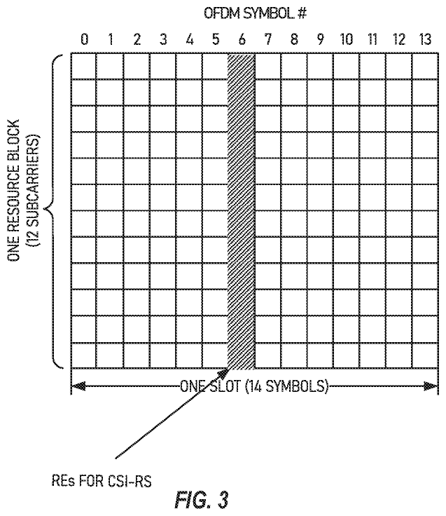

FIG. 4 illustrates a PDSCH with two layers is transmitted from two TRPs by applying two different precoding matrices to the PDSCH at TRP1 and TRP2;

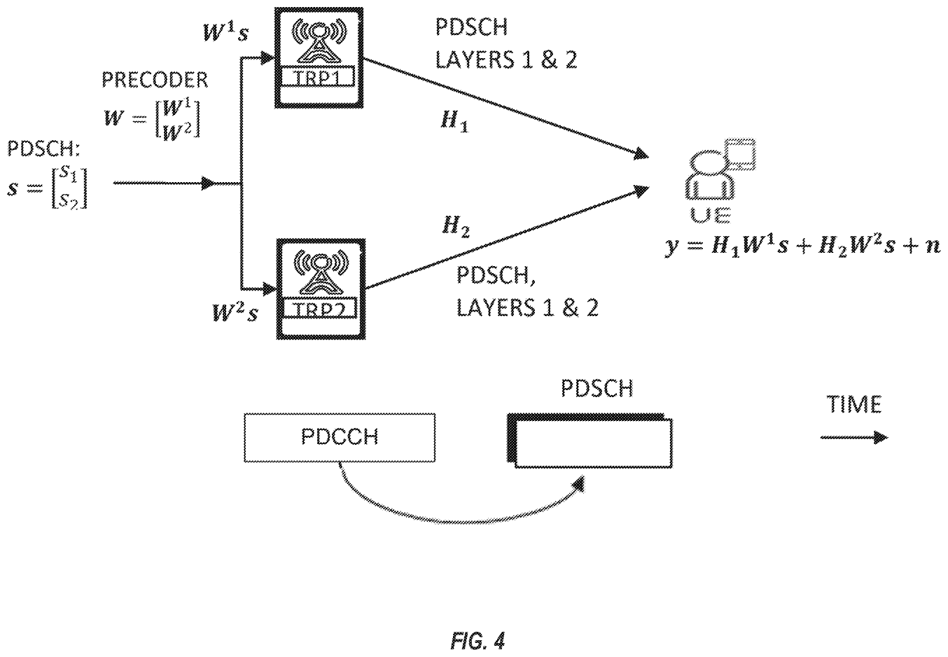

FIGS. 5A-5C illustrate flowcharts depicting some embodiments of the current disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Certain aspects of the disclosure and their embodiments may provide solutions to these or other challenges/problems mentioned earlier. In some embodiments disclosed herein, systems and methods for resolving the varying payload size problem for reporting K^{NZ} in Part 1 CSI are provided (e.g., by allocating a fixed and sufficient payload size). In the proposed embodiments, rules are defined on how to allocate a sufficient payload size for reporting K^{NZ}. For example, the rules may comprise the following:
Receive Type II CSI parameters including configuration of N_{L} parameter combinations whereas each of the N_{L} parameter combinations is composed of a set {L₁, L₂, . . . L_{N}_{_{TRP}}} wherein Lₙ represents the SD basis vectors corresponding to the n^{th} CSI-RS resource; and
Determine a first parameter combination among the parameter combinations that results in the maximum number of SD basis vector

$${\sum }_{n = 1}^{{N}_{TRP}} {L}_{n} ,$$

and determining the payload size of the number of Type II CSI non-zero coefficients to be reported as part of the CSI using the first parameter combination.

Certain embodiments may provide one or more of the following technical advantages. The proposed solution resolves the varying payload size problem for reporting K^{NZ} in Part 1 CSI, making it possible to decode Part 1 CSI without any ambiguity.

For Type II codebook enhancement for CJT with multiple configured CSI-RS resources, where each CSI-RS is transmitted in one CSI-RS resource from one of multiple TRPs, the complexity for finding the best combination of spatial domain (SD) basis vectors or beams across the multiple CSI-RS resources or TRPs increases exponentially with the number of CSI-RS resources or TRPs. One way to reduce the complexity is to configure a limited number of hypotheses on the combinations of number of SD basis vectors across the CSI-RS resources so that the UE only needs to evaluate the configured number of hypotheses and selects/reports one of the combinations.

For N_{TRP} configured CSI-RS resources, it has been agreed in 3GPP that the number of SD basis vectors to be selected for each of N_{TRP} configured CSI-RS resource is higher-layer configured by the gNB. Let Lₙ be the number of SD basis vectors to be selected from CSI-RS resource n, the number of SD basis vectors to be selected across all the CSI-RS resources is then given by {L₁, . . . , L_{N}_{_{TRP}}}. The gNB configures a set of N_{L} combinations or hypotheses of values for {L₁, . . . , L_{N}_{_{TRP}}}, the UE selects one of the N_{L} configured combinations and reports the selected hypothesis to the gNB.

For Rel-16 enhanced Type II (eType II) codebook, the maximum number of non-zero coefficients reported by a UE for rank 1, K₀, is defined as K₀=┌β2LM₁┐, where L is the configured number of SD basis vectors to be selected, M₁=PᵥN₃/R is the number of FD basis vectors to be selected for rank 1. Note that the value of K₀ is known to both gNB and the UE for a given codebook parameter configuration for Rel-16 eType II CSI. For Type II codebook enhancement for CJT, the value of K₀ should be calculated across all configured CSI-RS resources, e.g., K₀=┌β2LₜₒₜM₁┐, where Lₜₒₜ is the total number of SD basis vectors selected from N≤N_{TRP} selected TRPs. However, Lₜₒₜ may be different among the N_{L} hypotheses and furthermore, since the UE may further down-select N out of N_{TRP} CSI-RS resources, Lₜₒₜ is unknown until the UE has determined which one of the N_{L} SD basis vector hypotheses and which CSI-RS resources are selected. Note that which one of the N_{L} SD basis vector hypotheses and which CSI-RS resources are selected are reported by the UE as part of CSI part 1, and hence, the gNB does not know the selected hypothesis and the selected CSI-RS resources until the gNB receives the CSI report. Consequently, for Type II codebook enhancement for CJT, K₀ is unknown to the gNB before decoding a CSI report. Hence, reusing the legacy mechanism for reporting the NNZCs selected by the UE (K^{NZ}) in CSI Part 1, i.e., using ┌log₂(K₀)┐ bits for rank 1 and ┌log₂(2K₀)┐ bits for rank>1, will not work since the payload size depends on K₀ which cannot be known before decoding CSI Part 1.

In addition, the codebook parameter, e.g., β and/or the number of FD basis vectors, may depend on the selected SD basis vector hypothesis. In this case, the value of K₀ is also not known before decoding CSI Part 1.

### Determining the Size for Reporting K^{NZ}

Based on the above discussion, in a preferred embodiment, the payload size for reporting K^{NZ}, the NNZCs reported by the UE summed across all selected CSI-RS resources, is determined by the maximum possible value of K₀ over all pre-configured N_{L} hypotheses, denoted as K_{0,max}. For example, the payload size for reporting K^{NZ} is ┌log₂(K_{0,max})┐ bits for rank 1 if only rank 1 is enabled (e.g., via rank restriction) and ┌log₂(2K_{0,max})┐ bits if rank>1 is enabled.

To further explain the above, consider the following example. The gNB configures the UE with N_{TRP}=3 CSI-RS resources and N_{L}=2 hypotheses for SD basis vector selection, the first hypothesis being {L₁, L₂, L₃}={2, 2, 2} and the second hypothesis being {L₁, L₂, L₃}={4, 4, 4}. Then, for Rel-16 eType II CB based CJT CSI, the maximum possible value of K₀=┌β2LₜₒₜM₁┐ is obtained when the second hypothesis is selected and when all 3 CSI-RS resources are selected (even though the UE may not select all 3 CSI-RS resources when constructing the final PMI). Hence, in this case, K_{0,max}=┌24βM₁┐.

The above can also be extended to CJT CSI reporting based on refinement of Rel-17 further enhanced Type II port selection codebook. For Rel-17 further enhanced type II port selection CB, K₀=┌β2LM┐, where 2L=K₁=αP_{CSI-RS} is the number of to be selected CSI-RS ports out of P_{CSI-RS} CSI-RS ports of a configured CSI-RS resource, and α, β and M are configured parameters. For Rel-17 Type II codebook enhancement for CJT, it is envisioned that N_{L} hypotheses of values for {L₁, . . . , L_{N}_{_{TRP}}} would be configured and K_{0,max} would be determined among the hypotheses for determining the bit size for reporting K^{NZ} non-zero coefficients, i.e., ┌log₂(K_{0,max})┐ bits if only rank 1 is enabled (e.g., via rank restriction) and ┌log₂(2K_{0,max})┐ bits if rank>1 is enabled.

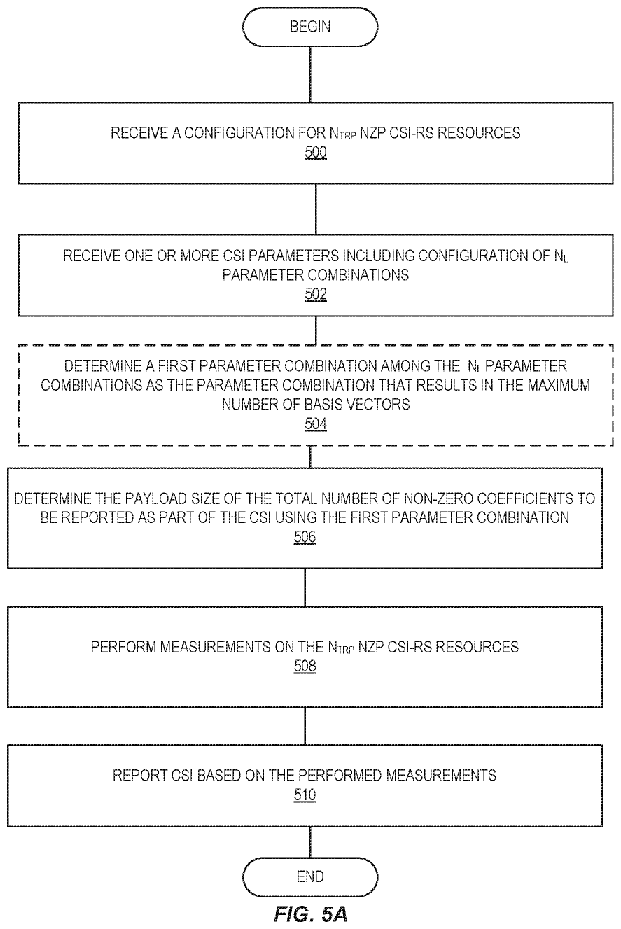

FIGS. 5A-5C illustrate some embodiments disclosed herein.

FIG. 5A illustrates a method of operating a UE for reporting CSI according to some embodiments. In some embodiments, the UE optionally receives (step 500) a configuration for N_{TRP} CSI-RS resources. The UE optionally receives (step 502) one or more CSI parameters including configuration of N_{L} parameter combinations. In some embodiments, the UE optionally determines (step 504) a first parameter combination among the N_{L} parameter combinations that results in the maximum number of basis vectors

$${\sum }_{n = 1}^{{N}_{TRP}} {L}_{n} .$$

The UE determines (step 506) a payload size of a number of CSI non-zero coefficients to be reported as part of the CSI using the first parameter combination. The UE performs (step 508) measurements on the N_{TRP} CSI-RS resources and optionally selects a second parameter combination among the N_{L} parameter combinations for determining the number of basis vectors chosen across the N_{TRP} CSI-RS resources for CSI. The UE reports (step 510) CSI based on the performed measurements.

FIG. 5B illustrates a method of operating a network node for receiving CSI according to some embodiments. In some embodiments, the network node optionally configures (step 512) a UE with a configuration for N_{TRP} CSI-RS resources. The network node optionally configures (step 514) the UE with one or more CSI parameters including configuration of N_{L} parameter combinations. In some embodiments, the network node optionally determines (step 516) a first parameter combination among the N_{L} parameter combinations that results in the maximum number of basis vectors

$${\sum }_{n = 1}^{{N}_{TRP}} {L}_{n} .$$

The network node determines (step 518) a payload size of a number of CSI non-zero coefficients to be reported by the UE as part of the CSI using the first parameter combination. The network node receives (step 520) CSI based on measurements performed on the CSI-RS resources.

A flowchart depicting the preferred embodiment is shown in FIG. 5C. In some embodiments, the first parameter combination among the N_{L} parameter combinations may be different from the second parameter combination among the N_{L} parameter combinations. The reason is that the first parameter combination is used to determine the payload size of the NNZC while the second parameter combination is used to indicate the actual number of SD basis vectors chosen across the N_{TRP} CSI-RS resources.

In some other embodiments, it may be so that β and/or M₁ (or p₁) are also varying, depending on which SD basis vector hypothesis is selected. Let us consider an example with two different parameter combination hypotheses:

$$Hypothesis 1 \text{:} \{ {L}_{1} , {L}_{2} , {L}_{3} \} = \{ 2 , 2 , 2 \} , β = 1 / 2 , {M}_{1} = 4$$

$$Hypothesis 2 \text{:} \{ {L}_{1} , {L}_{2} , {L}_{3} \} = \{ 4 , 4 , 4 \} , β = 1 / 8 , {M}_{1} = 2$$

For hypothesis 1, β2LₜₒₜM₁=24; and for hypothesis 2, β2LₜₒₜM₁=6. Hence, in this case, hypothesis 1 is selected for determining K_{0,max} which results in K_{0,max}=24. In this embodiment, K_{0,max} is determined using the parameter combination hypothesis that results in the maximum product β2LₜₒₜM₁. Note that when configuring the parameter combination hypothesis, the gNB may configure the parameter pᵥ instead of M₁, wherein

$${M}_{1} = ⌈ {p}_{1} \frac{{N}_{3}}{R} ⌉ .$$

In this example, if the corresponding CJT CSI report is restricted to rank 1, then 5 bits would be determined for reporting K^{NZ}, i.e., ┌log₂(K_{0,max})┐=┌log₂(24)┐=5 bits. Otherwise, if the rank can be more than 1 for the CJT CSI report, then 6 bits would be determined for reporting K^{NZ}, i.e., ┌log₂(2K_{0,max})┐=┌log₂(2×24)┐=6 bits.

In one embodiment, the configured N_{TRP} CSI-RS resources may be semi-persistent CSI-RS resources. In this case, it is possible that the gNB only activates via a Medium Access Control Control Element (MAC CE) a subset N′ of the N_{TRP} CSI-RS resources at a given time. In this embodiment, when calculating the maximum possible value of K₀=┌β2LₜₒₜM₁┐, only the SD basis vectors corresponding to the activated N′ semi-persistent CSI-RS resources out of the N_{TRP} CSI-RS resources are considered when calculating Lₜₒₜ. For example, considering the example N_{TRP}=3, {L₁, L₂, L₃}={2, 4, 6}, and that only the 1st and the 3rd CSI-RS resources are activated, then Lₜₒₜ=L₁+L₃.

In another embodiment, the configured N_{TRP} CSI-RS resources may be aperiodic CSI-RS resources. In this case, it is possible that the gNB only triggers via a DCI a subset N′ of the N_{TRP} CSI-RS resources at a given time. In this embodiment, when calculating the maximum possible value of K₀=┌β2LₜₒₜM₁┐, only the SD basis vectors corresponding to the triggered N′ aperiodic CSI-RS resources out of the N_{TRP} CSI-RS resources are considered when calculating Lₜₒₜ. For example, considering the example N_{TRP}=3, {L₁, L₂, L₃}={2, 4, 6}, and that only the 1st and the 3rd CSI-RS resources are triggered, then Lₜₒₜ=L₁+L₃.

The codebook parameters should be jointly configured so K₀ is always constant.

In another embodiment, the codebook parameters can be jointly configured in a way so that K₀ is a constant (or constant for given condition, e.g., for a given rank), no matter which SD basis vector hypothesis is selected and which CSI-RS resources are selected by the UE. This can be achieved by configuring the codebook parameters in certain combinations. For example, assuming the gNB configures the UE with N_{TRP}=3 CSI-RS resources and N_{L}=2 hypotheses for SD basis vector selection, the first hypothesis being {L₁, L₂, L₃}={2, 2, 2} and the second hypothesis being {L₁, L₂, L₃}={4, 4, 4}, for simplicity, further assuming that M₁ is constant and all CSI-RS resources are always selected. Then, β=0.5 when the UE selects the first hypothesis {L₁, L₂, L₃}={2, 2, 2}, while β=0.25 when the second hypothesis {L₁, L₂, L₃}={4, 4, 4}. Hence, βLₜₒₜ=6×0.5=12×0.25=3 is a constant, so that K₀=┌β2LₜₒₜM₁┐ is the same regardless which hypothesis is selected. With this joint configuration, there is no ambiguity in the value of K₀, so the legacy mechanism for reporting K^{NZ} can be reused.

In another embodiment, if the same number of SD basis vectors are configured for all N_{TRP} CSI-RS resources, β is configured so that βN is a constant. In some other embodiments, the β value is configured so that βL_{tot,max} or βN_{TRP} is a constant, where

$${L}_{tot , max} = {\sum }_{n = 1}^{{N}_{TRP}} {L}_{n} .$$

In another embodiment, the pᵥ (or p₁) value is configured so that pᵥLₜₒₜ (or p₁Lₜₒₜ) is a constant. In another embodiment, the pᵥ (or p₁) value is configured so that pᵥN (or p₁N) is a constant. In another embodiment, the pᵥ (or p₁) and the β values are configured so that βNMᵥ (or βNM₁) is a constant.

For example, assuming the gNB configures the UE with N_{TRP}=3 CSI-RS resources and N_{L}=2 hypotheses for SD basis vector selection, the first hypothesis being {L₁, L₂, L₃}={2, 2, 2} and the second hypothesis being {L₁, L₂, L₃}={4, 4, 4}, for simplicity, further assuming that M₁ is constant and all CSI-RS resources are always selected. Then, β=0.5 is jointly configured with the first hypothesis {L₁, L₂, L₃}={2, 2, 2}, while β=0.25 is jointly configured with the second hypothesis {L₁, L₂, L₃}={4, 4, 4}. Hence, K₀=┌β2LₜₒₜM₁┐ is the same regardless which hypothesis is selected. With this joint configuration, there is no ambiguity in the value of K₀, so the legacy mechanism for reporting K^{NZ} can be reused.

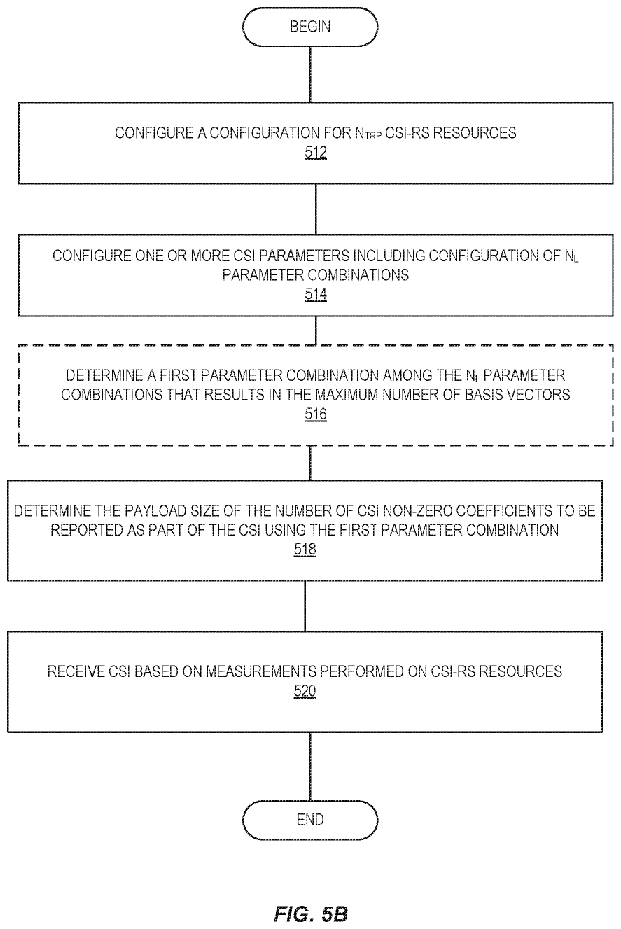

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar 3GPP access node or non-3GPP Access Point (AP). The network nodes 610 facilitate direct or indirect connection of UE, such as by connecting UEs 612A, 612B, 612C, and 612D (one or more of which may be generally referred to as UEs 612) to the core network 606 over one or more wireless connections. The UE 612 can be used to perform any of the methods disclosed herein, for example, the procedures of FIGS. 5A and 5C. The network node 610 can be used to perform any of the methods disclosed herein, for example, the procedures of FIG. 5B.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, NR, and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

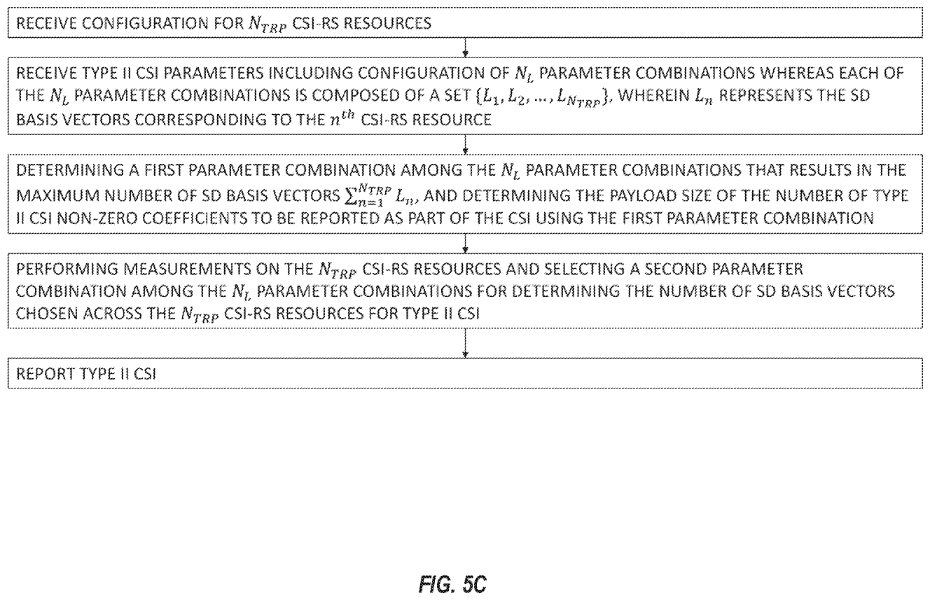

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

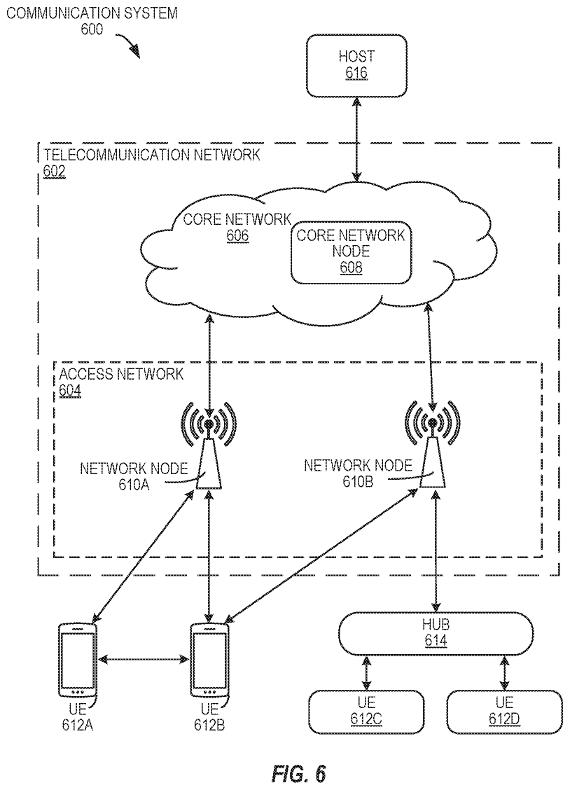

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

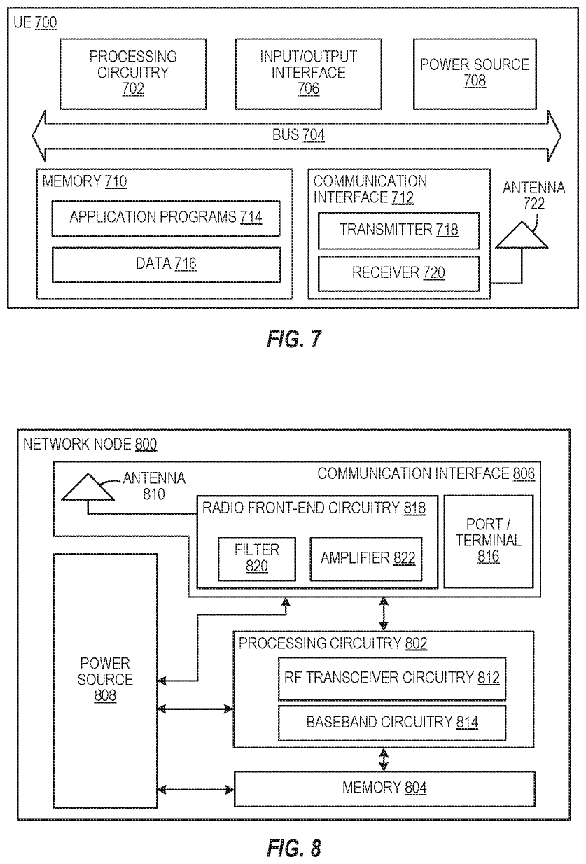

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

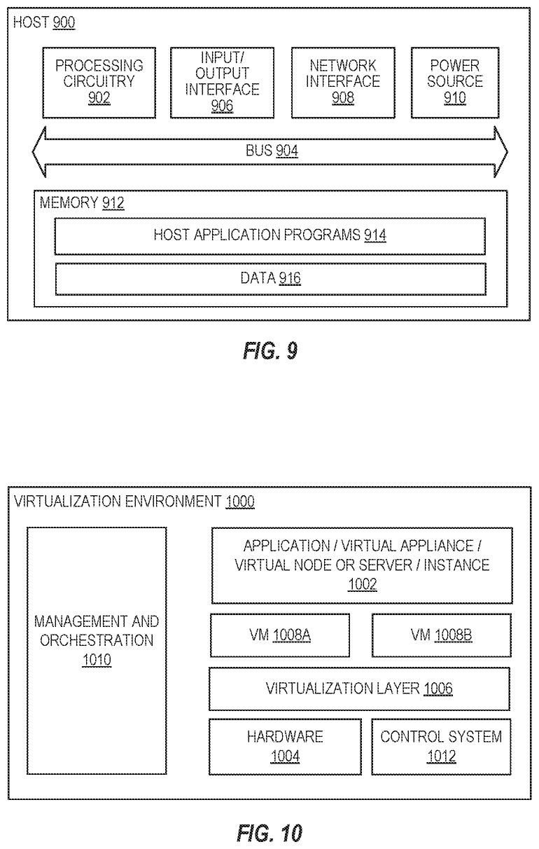

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

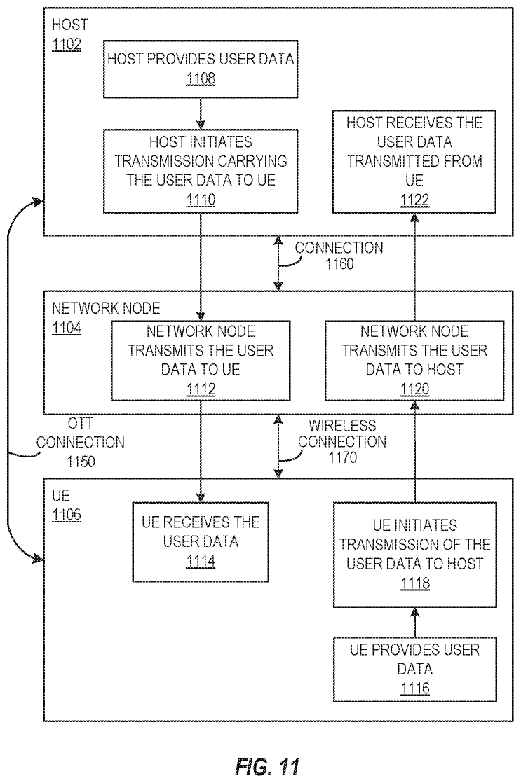

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

1. A method performed by a User Equipment (UE) for reporting Channel State Information (CSI) the method comprising:
receiving a configuration for a first number N_{TRP}>1 Non-Zero Power CSI Reference Signal (NZP CSI-RS) resources;
receiving one or more CSI parameters including configuration of a second number N_{L} parameter combinations, wherein each of the N_{L} parameter combinations is composed of a set {L₁, L₂, . . . , L_{N}_{_{TRP}}}, where Lₙ represents a number of spatial domain (SD) basis vectors corresponding to the n^{th} NZP CSI-RS resource;
determining a payload size of a total number Knz of non-zero coefficients to be reported as part of the CSI using a first parameter combination among the N_{L} parameter combinations;
performing measurements on the N_{TRP}>1 NZP CSI-RS resources; and
reporting the CSI based on the performed measurements.

2. The method of claim 1, further comprising:
determining the first parameter combination among the N_{L} parameter combinations as the parameter combination that results in the maximum number of basis vectors
$${\sum }_{n = 1}^{{N}_{TRP}} {L}_{n} .$$

3. The method of claim 1, wherein performing measurements on the N_{TRP}>1 NZP CSI-RS resources further comprises:
selecting a second parameter combination among the N_{L} parameter combinations for determining the number of basis vectors chosen across the N_{TRP}>1 NZP CSI-RS resources for CSI.

4. The method of claim 1, wherein:
the CSI parameters comprise Type II CSI parameters; and
reporting CSI comprises reporting Type II CSI.

5. The method of claim 1, wherein the basis vectors comprise Spatial Domain (SD) basis vectors.

6. The method of claim 1, further comprising allocating a payload size for reporting the total number of non zero coefficients, K^{NZ}, based on the determined payload size.

7. The method of claim 1, wherein the payload size for reporting K^{NZ} is determined by the maximum possible value of K₀=┌β2LₜₒₜM₁┐ over all pre-configured N_{L} hypotheses, denoted as K_{0,max}, wherein β is a higher layer configured parameter that controls a maximum number of reported non-zero coefficients, M₁ is the number of frequency domain (FD) basis vectors, and Lₜₒₜ is the total number of spatial domain basis vectors selected from selected from up to N_{TRP}>1 NZP CSI-RS resources.

8. The method of claim 1, wherein the payload size for reporting K^{NZ} is ┌log₂(K_{0,max})┐ bits for rank 1 if only rank 1 is enabled.

9. The method of claim 1, wherein the payload size for reporting K^{NZ} is ┌log₂(2K_{0,max})┐ bits if rank>1 is enabled.

10. The method of claim 1, wherein the first parameter combination among the N_{L} parameter combinations may be different from the second parameter combination among the N_{L} parameter combinations.

11. The method of claim 1, wherein the first parameter combination is used to determine the payload size for reporting K^{NZ} while the second parameter combination is used to indicate an actual number of SD basis vectors chosen across the N_{TRP}>1 NZP CSI-RS resources.

12. The method of claim 1, wherein β and/or M₁ are also varying, depending on which SD basis vector hypothesis is selected.

13. The method of claim 1, wherein K_{0,max} is determined using a parameter combination hypothesis that results in the maximum product β2LₜₒₜM₁.

14. The method of claim 7, further comprising, for a parameter combination hypothesis, receiving a configuration of a parameter pᵥ instead of M₁, wherein
$${M}_{1} = ⌈ {p}_{1} \frac{{N}_{3}}{R} ⌉ ,$$
wherein N₃ is the number of subbands for precoder matrix indicator, PMI, and R is a higher layer configured integer scaling factor.

15. The method of claim 7, wherein when calculating the maximum possible value of K₀=┌β2LₜₒₜM₁┐, only the SD basis vectors corresponding to an activated N′ semi-persistent NZP CSI-RS resources out of the N_{TRP}>1 NZP CSI-RS resources are considered when calculating Lₜₒₜ.

16. The method of claim 1, wherein receiving a DCI triggers a subset N′ of the N_{TRP} CSI-RS resources at a given time.

17. The method of claim 7, wherein when calculating the maximum possible value of K₀=┌β2LₜₒₜM₁┐, only the SD basis vectors corresponding to a triggered N′ aperiodic NZP CSI-RS resources out of the N_{TRP} CSI-RS resources are considered when calculating Lₜₒₜ.

18. A method performed by a network node for receiving Channel State Information (CSI) the method comprising:
configuring a User Equipment (UE) with a configuration for a first number N_{TRP}>1 Non-Zero Power (NZP) CSI Reference Signal (CSI-RS) resources;
configuring the UE with one or more CSI parameters including configuration of a second number N_{L} parameter combinations, wherein each of the N_{L} parameter combinations is composed of a set {L₁, L₂, . . . , L_{N}_{_{TRP}}}, where Lₙ represents a number of spatial domain (SD) basis vectors corresponding to the n^{th} NZP CSI-RS resource;
determining a payload size of a total number Knz of non-zero coefficients to be reported as part of the CSI using a first parameter combination among the N_{L} parameter combinations; and
receiving, from the UE CSI based on measurements performed on N_{TRP} CSI-RS resources.

19-32. (canceled)

33. A User Equipment (UE) comprising processing circuitry and memory, the memory comprising instructions to cause the UE to:
receive a configuration for N_{TRP}>1 Non-Zero Power CSI Reference Signal (NZP CSI-RS) resources;
receive one or more CSI parameters including configuration of N_{L} parameter combinations, wherein each of the N_{L} parameter combinations is composed of a set {L₁, L₂, . . . , L_{N}_{_{TRP}}}, where Lₙ represents a number spatial domain basis vectors corresponding to the n^{th} NZP CSI-RS resource;
determine a payload size of a number of Channel State Information (CSI) non-zero coefficients to be reported as part of the CSI using a first parameter combination among the N_{L} parameter combinations;
perform measurements on the N_{TRP}>1 NZP CSI-RS resources; and
report CSI based on the performed measurements.

34-35. (canceled)

36. A network node comprising processing circuitry and memory, the memory comprising instructions to cause the network node to:
configure the UE with a configuration for the N_{TRP}>1 CSI Reference Signal (CSI-RS) resources;
configure the UE with one or more CSI parameters including configuration of N_{L} parameter combinations, wherein each of the N_{L} parameter combinations is composed of a set {L₁, L₂, . . . , L_{N}_{_{TRP}}}, where Lₙ represents a number spatial domain basis vectors corresponding to the n^{th} Non-Zero Power CSI Reference Signal (NZP CSI-RS) resource;
determine a payload size of a number of Channel State Information (CSI) non-zero coefficients to be reported as part of the CSI using a first parameter combination among the N_{L} parameter combinations; and
receive, from a User Equipment (UE) CSI based on measurements performed on N_{TRP} CSI Reference Signal (CSI-RS) resources.

37-38. (canceled)
